(19) United States
(12) Patent Application Publication
(10) Pub. No.: US 2006/0045679 A1
(43) Pub. Date: Mar. 2, 2006

(54) Robotic retrieval apparatus

(76) Inventor: Eric Ostendorff, Torrance, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/919,534

(22) Filed: Aug. 16, 2004

(51) Int. Cl. B65F 9/00

(52) U.S. Cl. 414/402

(57) ABSTRACT

A robotic device and method of use for fetching an object, the method including driving the device until a docking signal is acquired and then toward the docking signal to dock with a docking element of a door of a storage cabinet or refrigerator, and then driving the device away from the door so as to open it and then rotating the device about the docking element to place a vertically extended pincer clamp of the device around a target object positioned at a specified location within the door, followed by closing the pincer clamp so as to grip the target object and rotating the device about the docking element while carrying the target object so as to close the door. The object is then carried by the device to a specified programmed location to deliver the object.

### RELATED APPLICATIONS

None

### INCORPORATION BY REFERENCE

Applicant hereby incorporates herein by reference, the U.S. patents and U.S. patent publications: 2003/0165373; 6543983; 5179843; 2001/0031604; 4889210; 5413454; 5332013; 5647554; and 4307891; and the PCT publications: WO 9902434 and WO 0209047 which are referenced in the Description of Related Art section of this application.

### BACKGROUND OF THE INVENTION

1. Field of the Invention

This invention relates generally to automated machines, and more particularly to a mobile robot capable of moving and acting in a preprogrammed manner, and further capable of mechanically interfacing with a stationary depot for retrieving an object.

2. Description of Related Art

The following art defines the present state of this field and each disclosure is hereby incorporated herein by reference:

Doornick et al., U.S. Pat. No. 4,607,891 describes a humanoid appearing robot adapted for movement relative to a ground support surface includes a removable passenger carrying platform attached to a base portion thereof. The platform serves to both provide the robot with a passenger carrying capability that enhances the entertainment value of the robot and to enhance the stability of the robot during movement relative to a ground surface. The platform may be removed when the passenger carrying capability is not desired or when it is necessary to maneuver the robot in confined spaced, e.g., the interior of a passenger carrying aircraft. Arm-like members are articulatably connected to a torso portion of the robot and include articulatable hand-like members for grasping and releasing small objects. The arm-like members are articulatable to a forwardly extended position to provide lateral support for a passenger on the platform. An articulatable head-like module is mounted on the torso portion to complement the robot's humanoid form.

Alcaraz et al., U.S. Pat. No. 4,889,210 describes a robot for serving a product dispensed from a product dispenser to a customer including a processor and a robotic arm. The processor stores a predetermined instruction set and generates command signals according to the instruction set. The robotic arm is responsive to certain ones of the command signals for transferring the dispensed product from a product dispense location to a position adjacent the customer for removal by the customer. The robot may further comprise a communications system for storing a set of predetermined messages and is responsive to certain other ones of the command signals for announcing selected ones of the messages. Furthermore, the robot may further include a transport system for transferring the dispensed product from the position adjacent the customer, the product dispense location and the position adjacent the customer beyond reach of the customer, to a position within reach of the customer.

Cohausz, U.S. Pat. No. 5,179,843 describes an invention that relates to a refrigerator for receiving foodstuffs and/or beverages, the refrigerator containing a traveling carriage, more particularly taking the form of a robot, which contains a refrigerated reception space for foodstuffs and/or beverages and can be driven out of the refrigerator and controlled automatically and/or remotely via an electronic system.

Sigita et al., U.S. Pat. No. 5,332,013 describes an unmanned conveying device for a clean room that is capable of restraining a spontaneous oxide film from growing in case that an unmanned carriage is obliged to stop for a long time due to its own cause of a cause at a destination spot while it conveys a semiconductor wafer from one spot to the destination spot. It is a first aspect of the invention to provide the unmanned conveying device which is self-propelled for conveying an object from a ground facility to a destination spot while loading an object to be conveyed thereon, characterized in that the object is accommodated in a container and the container is connected to an inert gas reservoir through a gas supply passage so that the atmosphere in the container can be replaced by a nitrogen gas. It is a second aspect of the invention to provide an unmanned conveying device for a clean room provided with a container for accommodating an object to be conveyed therein, the container being connected to an inert gas reservoir through a gas supply passage so that the air in the container can be replaced by a nitrogen gas, characterized in that the unmanned conveying device has a coupler unit mounted thereon and connected to the gas supply passage and the inert gas reserving source is located on the ground and connected to a coupler unit of a coupler device on the ground through a pipe and the gas supply passage is connected to the inert gas reservoir through both coupler unit.

Movsevian, U.S. Pat. No. 5,413,454 describes an invention that relates to a mobile robotic arm which is adapted to grasp objects at low-level, intermediate level and high reach areas of a domestic dwelling. The device generally comprises a mobile base having a robotic arm rotatably and pivotally connected thereto. The robotic arm comprises lower arm, mid-arm, and forearm components which are pivotally interconnected and selectively extensible and retractable through the utilization of a controller which is preferably disposed upon an arm rest portion of a wheelchair.

Ikegami et al., U.S. Pat. No. 5,647,554 describes an electric working apparatus that includes a movable body which is driven by a movement mechanism, and the movable body is provided with a working mechanism such as an articulated robot. The movement mechanism, the working mechanism and etc. are driven by an electric power which is supplied through a power supply cord being extended from a cord reel mechanism fixed on a wall or floor within a working space of the movable body to be connected to the movable body. When the movable body moves in a manner that the movable body goes away from the cord reel mechanism, a tension detection switch is turned-off by a lever, a reel motor is turned-off, and clutch plates are released, and therefore, the power supply cord is wound from the cord reel mechanism by necessary length. When the movable body moves in a manner that the movable body approaches to the cord reel mechanism, the tension detection switch is turned-on by the lever and the clutch plates are engaged to each other, and therefore, the cord reel is rotated by the reel motor to wind the power supply cord.

PCT WO/02/09047 describes a food vending apparatus that includes a kiosk 1 having trays of pre-prepared food products stored on trolleys. A customer may place an order using a keypad and an electronic payment card at one of several ordering and collection stations. A robot in the centre of the kiosk selects the food product and places it on the tray in a microwave oven where the product is heated. The robot then removes the heated product, selects the required drink from a drink dispenser and places it on the tray, and delivers the order to the customer waiting at the collection station.

Felder et al., U.S. Pat. No. 6,543,983 describes a pick up and delivery system for use with mobile robots which have a body with a horizontal upper surface and at least one vertical side. The robot has at least one shelf, each of which contains a stop bar containing a retaining device. The system further uses multiple stations, each of which contain at least one pallet retaining surface to contain at least two pallets. The pallet retaining surfaces are provided with a holding device at the pick up area and a holding device at the delivery area. Pallets are used to retain the items being transferred with each of the pallets having a securing device that interacts with the holding device and retaining device. The strength of the holding device at the pick up area is less than the holding device at the delivery area, with the robot's retaining device having a strength between the strength of the holding devices. The mobile robot picks up a pallet from a first station, and delivers the pallet to a second station.

Hornsby et al., U.S. Publication 2001/0031604 describes an interactive robotic device having a body, a transport mechanism, a drive mechanism, a plurality of inputs and outputs for receiving, delivering and/or displaying information, including aural and/or visual information or signals, a container for carrying or holding items to be delivered or dispensed to a user, and a dispensing structure for dispensing items to a user.

Felder et al., U.S. Publication 2003/0165373 describes a pick up and delivery system for use with mobile robots which have a body with a horizontal upper surface and at least one vertical side. The robot has at least one shelf, each of which contains a stop bar containing a retaining device. The system further uses multiple stations, each of which contain at least one pallet retaining surface to contain at least two pallets. The pallet retaining surfaces are provided with a holding device at the pick up area and a holding device at the delivery area. Pallets are used to retain the items being transferred with each of the pallets having a securing device that interacts with the holding device and retaining device. The strength of the holding device at the pick up area is less than the holding device at the delivery area, with the robot's retaining device having a strength between the strength of the holding devices. The mobile robot picks up a pallet from a first station, and delivers the pallet to a second station.

Our prior art search with abstracts described above teaches: a robotic pick up and delivery system, a remote controlled robotic refrigerator, an interactive dispensing amusement device, a robotic product server and system, a mobile robotic arm, an unmanned conveying device in for clean room operations, an electric working apparatus supplied with electric power through power a supply cord, a remote controlled robot with a person supporting platform, and a food vending apparatus. Thus, the prior art shows, that it is known to use a robotic device to move objects and personnel from one place to another, to program robots to do both simple and complex manipulations including moving on a plane over a selected course. The prior art clearly shows that robotic devices are programmable to grip objects and to move the objects as programmed. It is known to move a refrigerator robotically, i.e., via a program. The prior art also teaches the enablement of docking a robot and controlling a robot via wireless communication. However, the prior art fails to teach a robotic device that is able to dock with a storage depot, open its door and acquire an object placed at a selected point; then close the door and move the object to a delivery location. The present invention fulfills these needs and provides further related advantages as described in the following summary.

### SUMMARY OF THE INVENTION

The present invention teaches certain benefits in construction and use which give rise to the objectives described below.

In a best mode method of using a mobile robotic device for fetching an object, method steps include driving the device until a docking signal is acquired at a fetch location and then toward the docking signal to dock with a docking element of a door of a storage cabinet or refrigerator. The device is then driven away from the door so as to open it; followed by rotation about the docking element to place a vertically extended pincer clamp of the device around a target object positioned at a specified location within the door. This is followed by closing the pincer clamp so as to grip the target object and then rotating the device about the docking element while carrying the target object so as to close the door. The object is then carried by the device away from the storage point to a specified preprogrammed location to deliver the object.

A primary objective of the present invention is to provide an apparatus and method of use of such apparatus that yields advantages not taught by the prior art.

Another objective of the invention is to provide a robotic device that is able to be programmed to home on a storage depot, acquire an object, and then move the object to a predetermined location.

A further objective of the invention is to enable the robotic device to move from a known initial location, for instance where on-board batteries are recharged, to a storage depot to fetch an object set at a pre-selected location in the storage depot, and then to deliver the object to a target location and then return to the initial location.

A still further objective of the present invention is to be able to grip an object at a first height and then lower the object to a height suitable for stable mobility of the robotic device.

A still further objective of the invention is to provide a robotic device with drive and steering functions performed by a single wheel.

A still further objective of the invention is to provide a robotic device capable of homing on a docking port of a storage depot, open a depot door, acquire an object, close the door and then move to a predetermined delivery location.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 is a perspective view of one embodiment of the present invention robotic device;

FIGS. 2-15 are plan views thereof showing the preferred method of operation of the robotic device including:

FIG. 2, wherein the device is shown moving in a direction perpendicular to a docking signal;

FIG. 3, wherein the device is shown acquiring the docking signal;

FIG. 4, wherein the device is shown turning 90 degrees to reacquire the docking signal;

FIG. 5, wherein the device is shown approaching a docking element of a stationary depot guiding on the docking signal;

FIG. 6, wherein the device is shown docking with the docking element of the depot wherein a pincer clamp of the device is locked into a closed position on the docking element;

FIG. 7, wherein the device is shown moving away from the depot to start to open a door of the depot;

FIG. 8, wherein the device is shown turning so as to place rear axles of the device in line with a hinge of the door;

FIG. 9, wherein the device is shown rotating the door open by approximately 90 degrees;

FIG. 10, wherein the device is shown rotating about the docking element to place a second pincer clamp of the invention around an object to be retrieved from the depot;

FIG. 11, wherein the device is shown closing the second pincer clamp so as to grip the object to be retrieved;

FIG. 12, wherein the device is shown rotating about the docking element to assume the position of FIG. 9;

FIG. 13, wherein the device is shown in a position having just closed the door; the position of FIG. 6;

FIG. 14, wherein the first pincer clamp of the device is shown releasing the docking element;

FIG. 15, wherein the device is shown moving away from the docking element carrying the object to be retrieved;

FIGS. 16A and 16B are perspective views showing, in FIG. 16A, at the moment when the device arrives at the delivery point, and in FIG. 16B, when the retrieved object is offered; and

FIG. 17 is an electrical schematic diagram of the robotic device.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

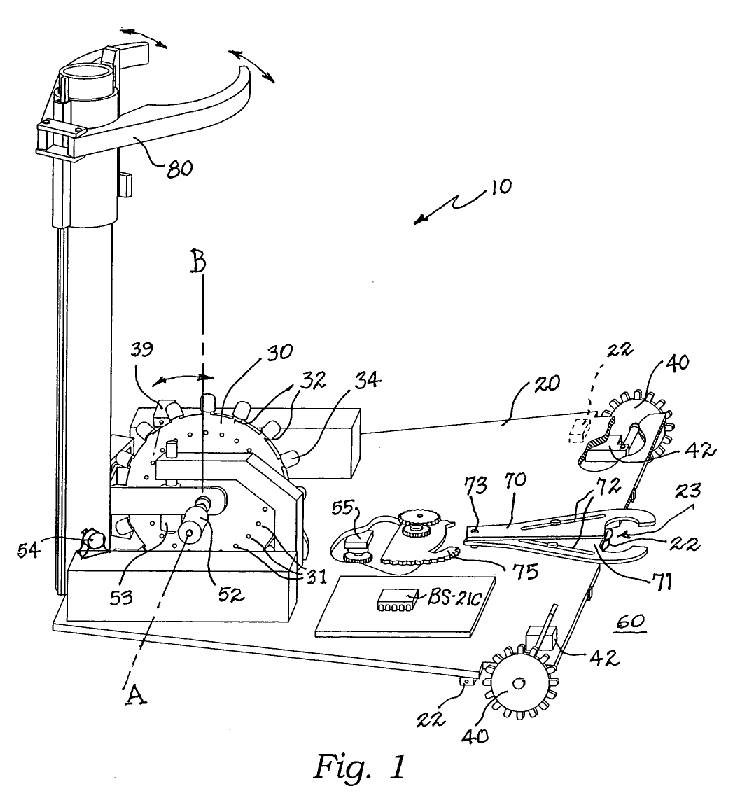

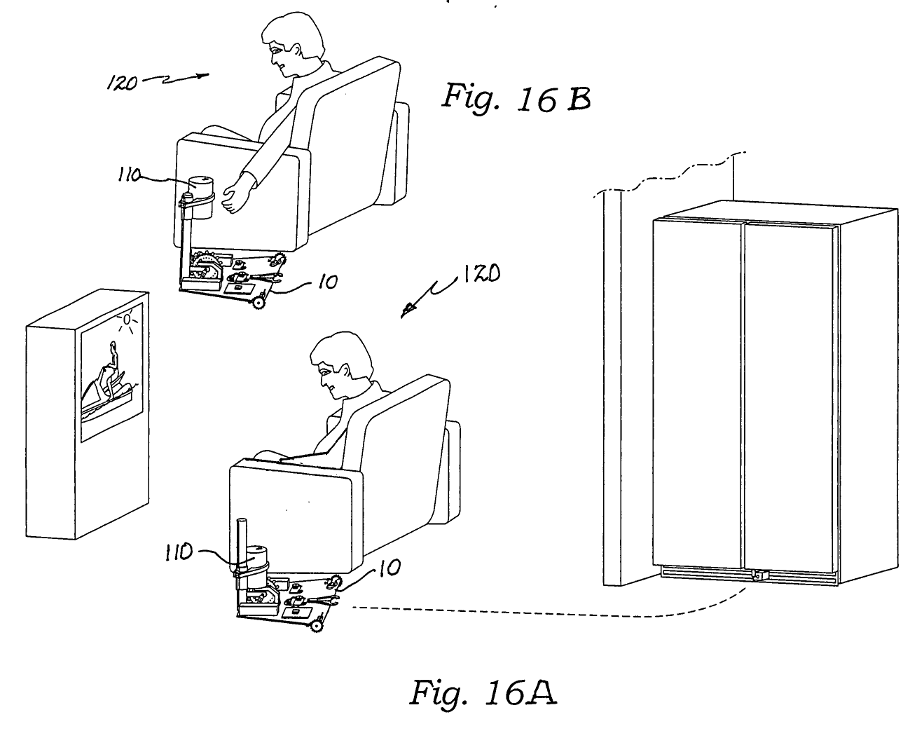

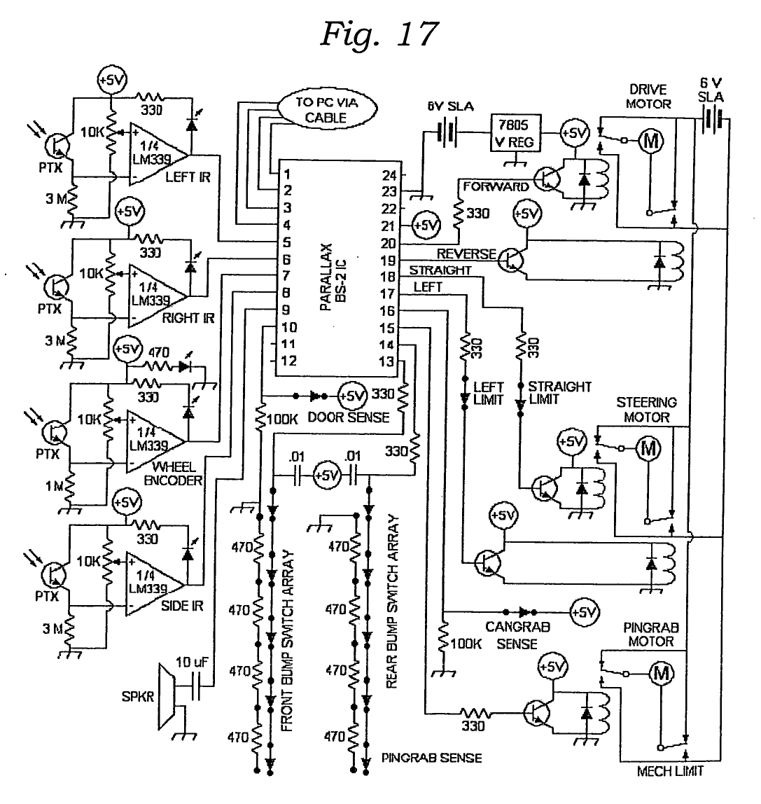

The present invention, as shown in FIG. 1, includes a mobile robotic device 10 having a horizontal platform 20 supported on a drive wheel 30 and at least two further spaced apart wheels 40. A drive system including, in the preferred embodiment, several small electric motors 52, 53, 54, and 55, engages the drive wheel 30 for rotation about a horizontal axis “A” (motor 52) in moving the robotic device 10 over a preprogrammed path on a supporting surface 60, such as a floor, while the drive system further engages the drive wheel 30 for rotation about a vertical axis “B” (motor 53) in steering the robotic device 10 on the supporting surface 60. A first 70 and a second 80 pincer clamps, are each movable between an open (shown in FIG. 1), and a closed attitude shown in FIGS. 7 and 11 respectively, the first of the clamps 70 extending outwardly from the platform 20, the second of the clamps 80 selectively positionable above the platform 20 in an extended (FIG. 1) or a retracted (FIG. 16) position. Referring now to FIG. 17, the electrical schematic diagram of the robotic device 10, a BASIC Stamp 2 controller BS-2 IC is programmed to read a variety of input conditions of optical sensors and electrical switches, and use relays to control three or more motors 52-55 to drive and steer the platform 20 and activate the device's features. The BS-2 IC and electronic circuitry is powered by a 6-volt, 3-Ah sealed lead acid (SLA) battery regulated to 5 volts by a 7805 voltage regulator, as shown in FIG. 17. The BS-2 IC is programmed through a 4-conductor cable connected to the serial port of a PC. The PC is not shown in FIG. 17. Various user routines are incorporated so that the device 10 is able to be taught the best path on supporting surface 60 to avoid obstacles such as furniture and such. Alternatively an on-board keypad may be used.

An IR navigation beacon (docking transmitter 96) is mounted on the depot 90 and also on a recharger which is not shown. Both use DC light levels, so simple light level detectors (signal receivers 22) in optical baffles are used for side and rear IR detection on platform 20. Sensitive phototransistors in series with 3-megohm resistors form voltage divider circuits. Signals from these voltage dividers are fed into 339 quad comparators for comparison against an adjustable reference voltage from a 10K potentiometer. The IR sources can be detected reliably up to 5 feet away in a typical household environment. A drive wheel optical encoder also uses a phototransistor voltage divider and 339 comparator. Holes 31 in the drive wheel 30 interrupt the phototransistor's view of an on-board IR LED 39 while the wheel 30 is rotating to measure distance traveled. The comparators' digital output is read directly by the BS-2 IC so that the BS-2 processor knows the status of all of the IR detectors 22.

Preferably, mechanical switches are used for bump switches (not shown) around the device 10: left front, center front, right front, left rear wheel 40 and right rear wheel 40. Such bump switches are widely known in the art and used to detect collisions and navigate accordingly. Mechanical switches also are used for the door sense lever 42, pin grab sensor, can grab sensor, as well as the two extreme travel limits of the steering assembly, straight ahead or full left. All switches except the steering limit switches are multiplexed and readable by the BS-2 IC. Normally-closed steering limit switches are hardwired into the steering motor's relay control circuitry for maximum protection of the steering gear train. There are no mechanical clutches on the robot's steering or drive system. A 5-volt piezoelectric beeper (speaker) is activated by the BS-2 IC to indicate various conditions.

The drive 52 and steering 53 motors are switched by two BS-2 IC controlled SPDT relays which provide dynamic braking in the off position to quickly stop the motors in the desired position. The pin grab motor 55 uses one BS-2 IC controlled SPDT relay and one SPDT slide switch. The slide switch is reversed at each extreme limit by the travel of the locking gear, so that the locking gear is always toggled to one of its extreme mechanical limits. All the motors are driven by a separate 6-volt, 3 Ah gel cell.

The invention further provides for a storage depot 90 such as a pantry or refrigerator, providing a door 92 having a door pull 94, the door pull 94 placed for engagement by the first pincer clamp 70. Such a door pull 94 may be attached to the bottom surface of the door 92 by a bonding adhesive or other common attachment scheme and preferably comprises a vertically oriented shaft or pin around which the first pincer clamp 70 is able to encircle. The closure of pincer clamp 70 does not grip the door pull 94 tightly, so that the device 10 is able to rotate about the door pull shaft 94 while using the door pull 94 as a point about which to rotate. This enablement provides for certain advantages, as will be shown below in the operation of the device relative to the storage depot 90, and forms a basis for the successful operation of the device 10 in retrieving an object from within the depot 90.

A shelf 100 is positioned in the door 92 and provides one or more objects 110 for retrieval by the robotic device 10. In FIG. 9 the door 92 is shown in an open attitude with shelf 100 supporting objects 110, such as beer, soft drinks other beverage containers such as cans or bottles. Preferably, the objects 110 are cylindrical in shape and are placed on an inclined ramp 100′ which is supported on shelf 100 (not shown, but is under the ramp 100′) so that the objects are able to roll under gravitational force toward a dispatch point, identified by arrow “C” in FIG. 9. When one of the objects 110 is pulled off ramp 100′ by pincer clamp 80, the next object on ramp 100′ is able to roll into a hinged object cage which is biased to move in line with the ramp 100′ when the object 110 is removed, but which, under the weight of the object 110 is forced to rotate about a hinge to place the object 110 in a vertical upright attitude ready to be gripped and withdrawn by the robotic device 10. Position “C” is the exact spot that the second pincer clamp 80 positions itself to clamp around the object 110.

The depot door 92 provides clearance thereunder for passage of the platform 20 of the device 10, and this relationship, i.e., the low position of the platform 20 enables the operational relationship between device 10 and the objects that move into position “C” on the door 92, so that they may be retrieved, as will be described. To accomplish this, the first 70 and second 80 pincer clamps are spaced apart such that with the first pincer clamp engaging the door pull 94, the robotic device 10 is able to rotate for positioning the platform 20 under the door 92 thereby placing the second 80 of the pincer clamps exactly adjacent to the shelf 100 for gripping the object 110 in position “C”.

The device 10 is constructed and programmed for fetching the object 110 from the depot 90. Such a program having the ability to “learn” and to thereafter carry-out a complex operation is well known in principle, and described in the prior art, as for instance in robotic lawn mowers and household vacuum cleaners, etc. The prior art references, which are incorporated into this disclosure by reference also clearly teach such enablements. The device 10 uses this technology.

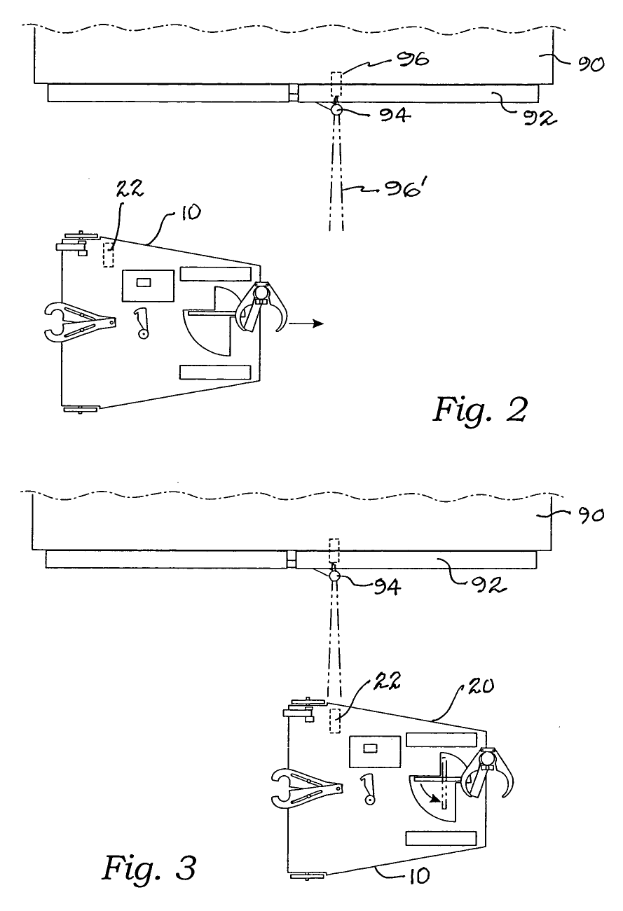

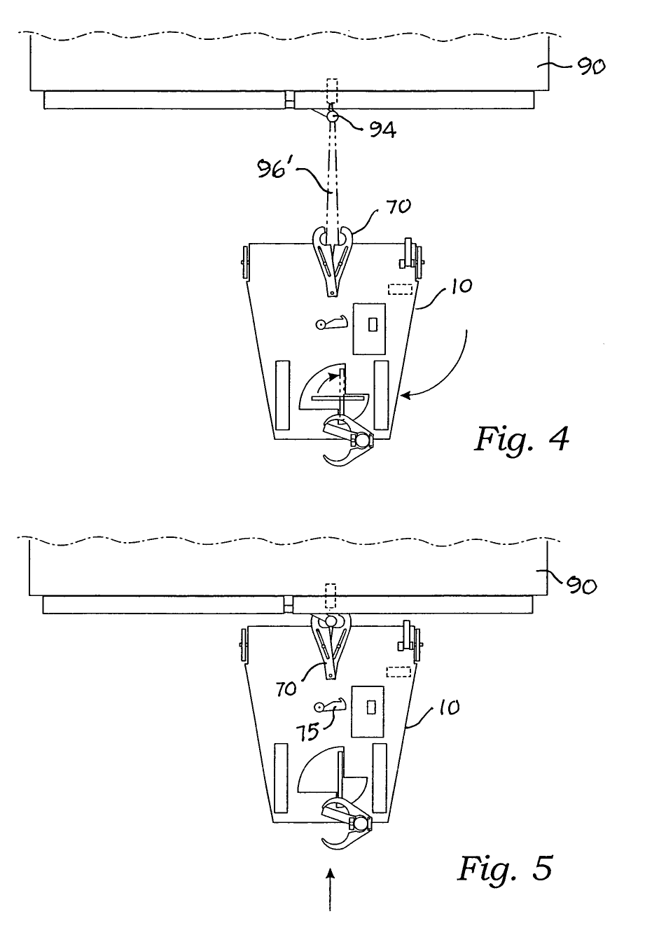

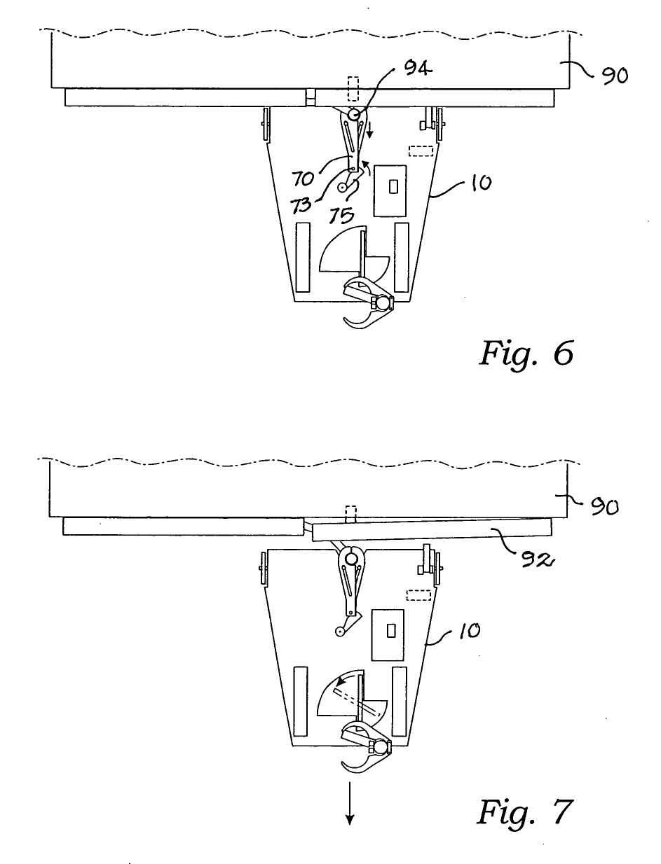

The method of the present invention includes placing the device 10 at a known initial location (not shown) on the supporting surface 60; usually a charging station wherein the device 10 is maintained at full battery charge. The process is initiated by signaling the device 10, using any well known remote control hand-held device and wireless method, to initiate its object-retrieval preprogrammed sequence. Next, the device 10 moves from its initial location, over a first preprogrammed course of movement on the supporting surface 60 into sensory distance of a docking signal 96′ which is either always present or initiated when the device 10 is. The docking signal 96′ is emitted by a docking transmitter 96 using an infrared light beam or similar directed signaling energy, as shown in FIG. 2. The program preferably positions the path of movement of the device 10 approximately orthogonal to a direction of the docking signal 96′ so that when a signal receiver 22 on board the device 10 “sees” the docking signal 96′, the device 10 is halted (FIG. 3) and then the drive wheel 30 is rotated as shown in FIG. 3. The method further includes turning the device 10 using wheel 30 until further signal receivers 22, mounted side-by-side at location 23 pick up signal 96′. Then the device 10 is driven toward the signal 96′ while maintaining its lock on the docking signal 96′. This is accomplished because the two further signal receivers 22 signal for a change in direction to motor 53 if either looses the signal 96′ until it is once again received. Docking element 94 is just below and vertically aligned with signal 96. This keeps the device 10 moving directly toward the transmitter 96 until docking element 94 makes contact with the interior 71 of clamp 70 (FIG. 5), pushing the clamp 70 along grooves 72 and thereby closing the pincer clamp 70 around docking element 94, as shown in FIG. 6. The clamp 70 is locked in its closed attitude my motor 55 which drives finger 75 under latching pin 73 as shown in FIG. 6.

While gripping the docking element 94, the device 10 is able to open the door 92 by pulling on element 94 as shown in FIG. 7. When the door 92 is a refrigerator, the initial pull is used to disengage the magnetic door latch with mechanical advantage provided by pivoting docking element 94. Traction on various floor surfaces is accomplished by the drive wheel 30. As shown in FIG. 1 this wheel has peripheral fingers 32, which are able to grip deeply into carpet and similar surfaces. Each of the fingers 32 is covered by a high friction rubber cot 34 for friction on hard surfaces.

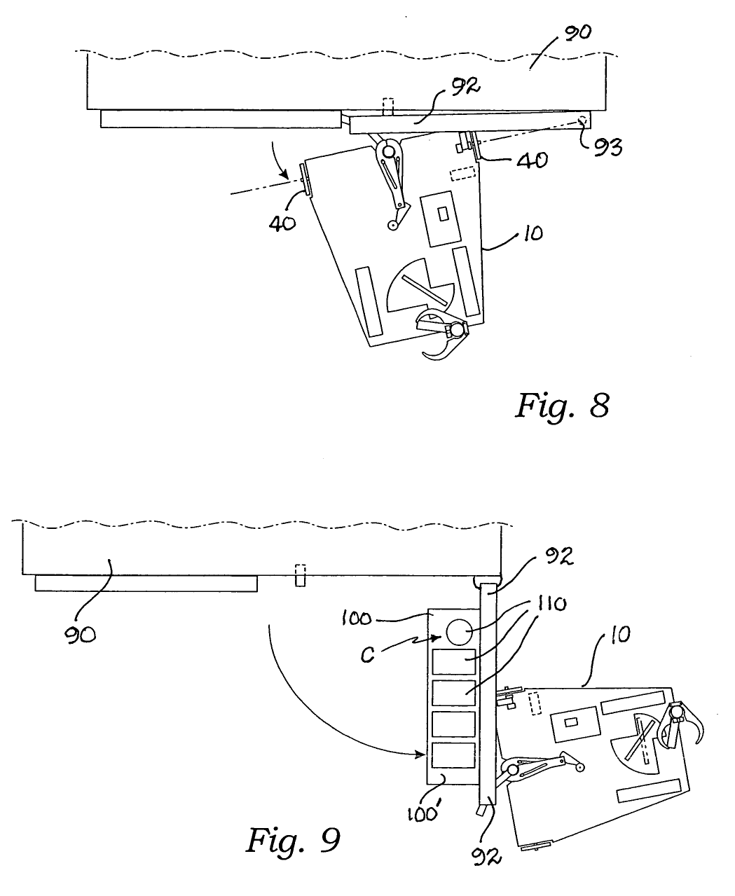

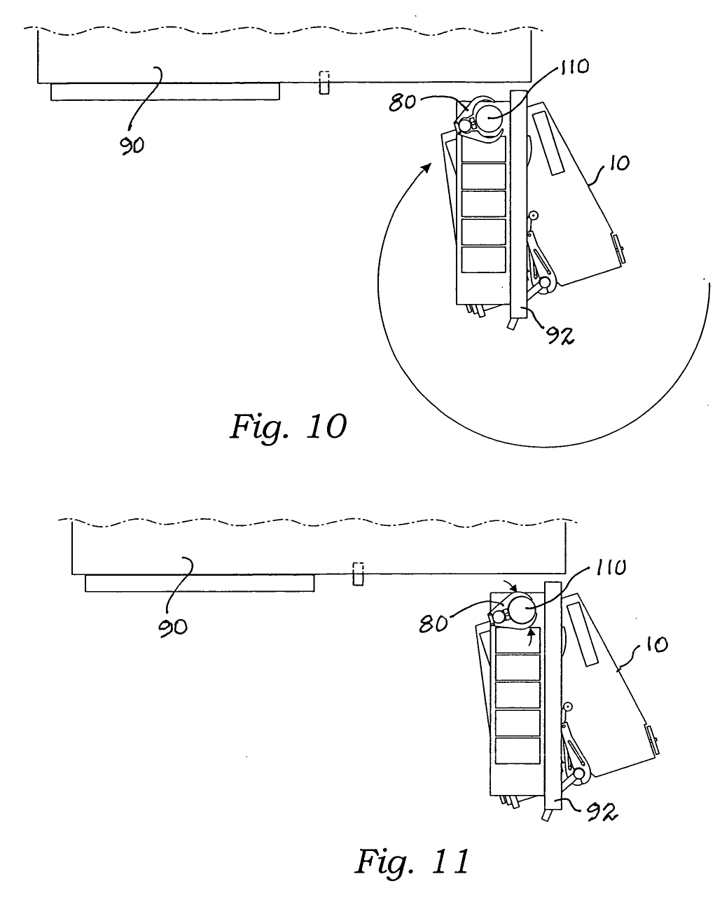

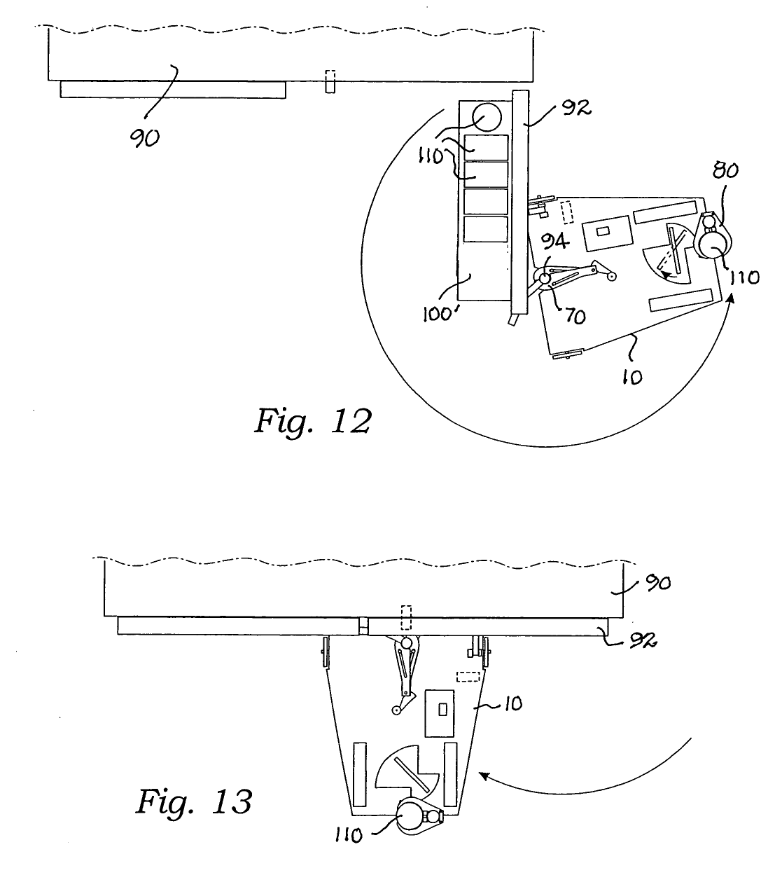

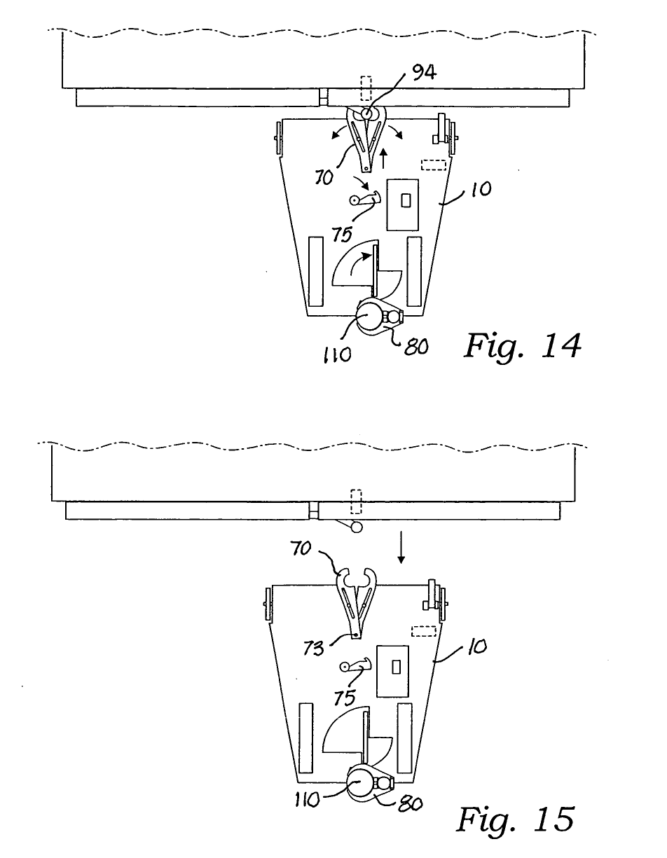

As shown in FIG. 8, the device 10 is then turned so that the axles of wheels 40 are in line with a hinge 93 of the door 92. Next the method includes driving the device 10 while pulling tangentially on the door 92 so as to rotate it by approximately 90 degrees, as shown in FIG. 9. Next, the device 10 rotates about the docking element 94 to place a vertically extended second pincer clamp 80 (see FIG. 1) of the device 10 around a target object 110 positioned within the door, at position “C” (FIG. 10), and closes the second pincer clamp 80 so as to grip the object (FIG. 11). Then the device 10 is rotated in reverse order about the docking element 94 to place the axle of wheels 40 again in line with hinge 93, as shown in FIG. 12, while carrying the object 110 by the second pincer clamp 80. Finally, the method includes driving the device 10 to close the door 92 (FIG. 13), releasing the docking element 94 by opening pincer clamp 70 using motor 55 to slide finger 75 to the right in FIG. 14 to release latching pin 73, pulling away from the depot 90 (FIG. 15) and driving the device 10 over a preprogrammed second course of movement on the supporting surface 60 while carrying the object 110 to a preprogrammed object delivery point 120.

The method further preferably includes the step of vertically retracting the second pincer clamp 80 after the object 110 is removed from the shelf 100 so as to lower the center of mass of the device 10 during movement over the supporting surface 60 and then vertically extending the second pincer 80 using motor 54 to turn a screw to raise the object 110 so as to offer it to be taken from the second pincer clamp 80 when the device 10 reaches its delivery point 120, a preprogrammed location. Please refer to FIGS. 16A and 16B.

The method further includes driving the device 10 from the delivery point 120 over a third preprogrammed course of movement which results in the device 10 terminating at the initial position on the supporting surface 60, which completes the cycle of activation, fetching, delivering and terminating.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A method of using a mobile robotic device for fetching an object, the method comprising the steps of:
placing the apparatus at a known initial location on a two dimensional plane;
signaling the device to initiate an object retrieval sequence;
moving the device from the initial location, over a first preprogrammed course of movement on the two dimensional plane into a vicinity of a docking signal wherein the device is driven along a path approximately orthogonal to a direction of the docking signal;
receiving the docking signal at a first docking sensor on the device as the device moves past the docking element, whereupon the device is halted;
turning the device to move toward the docking signal while locked onto the docking signal;
driving the device toward a source of the docking signal;
docking the device with a docking element of a door of a storage depot by gripping the docking element with a first pincer clamp of the device;
driving the device away from the depot so as to open the door of the depot while turning the device to place a rear axle thereof in line with a hinge of the door;
driving the device so as to rotate the door by approximately 90 degrees;
rotating the device about the docking element to place a vertically extended second pincer clamp of the device around an object positioned within the door;
closing the second pincer clamp so as to grip the object;
rotating the device about the docking element to place the axle of the device in line with the hinge of the door while carrying the object by the second pincer clamp;
driving the device to close the door;
releasing the docking element;
driving the device over a preprogrammed second course of movement on the two dimensional plane while carrying the object to a preprogrammed object delivery point.

2. The method of claim 1 further comprising the step of vertically retracting the second pincer clamp when the object is removed from the shelf of the door so as to lower the center of mass of the device during movement thereof over the two dimensional plane.

3. The method of claim 2 further comprising the step of vertically extending the second pincer to raise the object so as to offer the object to be taken from the second pincer clamp.

4. The method of claim 1 wherein the second preprogrammed course of movement results in the device terminating at the initial position on the two dimensional plane.

5. A method of using a mobile robotic device for fetching an object, the method comprising the steps of:
driving the device until a docking signal is acquired;
driving the device toward the docking signal;
docking the device with a docking element of a door of a storage depot;
driving the device away from the depot while gripping the docking element so as to open the door by approximately 90 degrees;
rotating the device about the docking element to place a vertically extended pincer clamp of the device around a target object positioned within the door;
closing the pincer clamp so as to grip the target object;
rotating the device about the docking element while carrying the target object by the pincer clamp;
driving the device to close the door;
releasing the docking element;
driving the device while carrying the target object to a preprogrammed object delivery point.

6. The method of claim 5 further comprising the step of vertically retracting the pincer clamp when the object is removed from the door so as to lower the center of mass of the device.

7. The method of claim 6 further comprising the step of vertically extending the pincer clamp to offer the object to be taken from the pincer clamp.

8. A combination apparatus comprising:
a mobile robotic device having a horizontal platform supported on a drive wheel and at least two further spaced apart wheels; a drive system engaging the drive wheel for rotation about a horizontal axis in moving the robotic device over a programmed path on a supporting surface, the drive system further engaging the drive wheel for rotation about a vertical axis in steering the robotic device over the supporting surface; a first and a second pincer clamps, each movable between an open and a closed attitude, the first of the clamps extending outwardly from the platform, the second of the clamps selectively positionable above the platform;
and a storage depot providing a door having a door pull, the door pull placed for engagement by the first pincer clamp; the depot door providing, and a shelf positioned for receiving, the second pincer clamp for gripping objects on the shelf, the depot door further providing clearance thereunder for passage of the platform, the first and second pincer clamps spaced apart such that with the first pincer clamp engaging the door pull, the robotic device is able to rotate for positioning the platform under the door thereby placing the second of the pincer clamps adjacent to the shelf for gripping an object.
